(19) United States
(12) Patent Application Publication
(10) Pub. No.: US 2009/0178591 A1
(43) Pub. Date: Jul. 16, 2009

(54) Carbohydrate-gypsum composite

(75) Inventors: Joel J. Pawlak, Raleigh, NC (US); Sa Yong Lee, Raleigh, NC (US)

Correspondence Address: THE ECLIPSE GROUP LLP, 10605 BALBOA BLVD., SUITE 300, GRANADA HILLS, CA, 91344, US

(73) Assignee: North Carolina State University, Raleigh, NC (US)

(21) Appl. No.: 12/008,414

(22) Filed: Jan. 11, 2008

(51) Int. Cl. C04B 11/00; B05D 3/00

(52) U.S. Cl. 106/780; 106/779; 524/5; 427/372.2

(57) ABSTRACT

A carbohydrate-gypsum composite for use as a bonding agent in manufacturing gypsum construction materials is disclosed. The composite includes a carbohydrate substituted with sulfate moieties such as cellulose sulfate and a crystalline calcium sulfate dihydrate. The composite may be used in bonding paper cover sheets to a gypsum core to form a gypsum wallboard. Also disclosed are methods of making the composite and methods of making gypsum wallboard with the composite.

### BACKGROUND OF THE INVENTION

1. Field of the Invention

This invention relates to gypsum wallboard and, more particularly, to a carbohydrate-gypsum composite for bonding paper to gypsum core in gypsum wallboard as well as to methods of making the composite and methods of making gypsum wallboard containing the composite.

2. Related Art

Typically, gypsum wallboard is made up of a gypsum core sandwiched between two sheets of paper backing. In the manufacturing process, the gypsum is first obtained as calcium sulfate dihydrate, which is then dried and calcined to yield stucco, i.e. calcium sulfate hemihydrate. The stucco is then formed into a slurry by mixing with water along with other additives such as reinforcing agents, surfactants and preservatives. This mixture is then introduced between two sheets of paper and allowed to set. The stucco slurry forms a gypsum core of crystallized calcium sulfate dihydrate which is then dried in a kiln to remove excess water to constitute the final gypsum wallboard product.

During the crystallization and drying, bonding takes place between the paper sheets and the core. Secure bonding of the paper and gypsum core is essential in maintaining the integrity of the wallboard. This is particularly important inasmuch as a substantial portion of the strength of gypsum wallboard may be derived from the paper backing. Therefore, there is a need for compositions and methods for effectively bonding the paper backing and gypsum core in gypsum wallboard.

### SUMMARY

Accordingly, the inventors herein have succeeded in devising a carbohydrate-gypsum composite for use as a bonding agent in manufacturing gypsum construction materials. The composite includes a substituted carbohydrate component and a gypsum component. The carbohydrate component is substituted with sulfate moieties and the gypsum component may be gypsum, i.e. calcium sulfate dihydrate or a precursor thereof. The composite may be used in bonding paper cover sheets to a gypsum core to form a gypsum wallboard.

Thus, in one implementation, the present invention provides a carbohydrate-gypsum composite. The composite includes (i) a carbohydrate component that is a carbohydrate substituted with sulfate moieties and (ii) a gypsum component that is gypsum or a precursor of gypsum. In some implementations, the substituted carbohydrate component may be cellulose sulfate and the gypsum component may be calcium sulfate dihydrate. In some implementations, the composite may be formed by crystallizing gypsum in the presence of the substituted carbohydrate.

In another implementation, the present invention provides a method for making a carbohydrate-gypsum composite that includes (i) a carbohydrate substituted with sulfate moieties and (ii) gypsum or a precursor thereof. The method includes providing a carbohydrate substituted with sulfate moieties and combining the substituted carbohydrate with gypsum or a precursor thereof to form the composite. In some implementations, providing the substituted carbohydrate may include reacting unsubstituted carbohydrate with sulfuric acid to produce the substituted carbohydrate. In some implementations, combining the substituted carbohydrate with gypsum or a precursor thereof may include crystallizing the gypsum in the presence of the substituted carbohydrate.

In another implementation, a paper cover sheet for use in manufacturing gypsum construction material is provided. The paper cover sheet has a bond surface coated with a carbohydrate-gypsum composite that includes (i) a carbohydrate substituted with sulfate moieties and (ii) gypsum or a precursor of gypsum. In some implementations, the substituted carbohydrate may be cellulose sulfate and the gypsum or precursor thereof may be calcium sulfate dihydrate.

In still another implementation, the present invention provides a method for making a paper cover sheet for use in manufacturing gypsum construction material. The method includes providing a composite that includes (i) a carbohydrate substituted with sulfate moieties and (ii) gypsum or a precursor gypsum, providing a paper cover sheet having a bond surface and applying the composite to the bond surface of the paper cover sheet. In some implementations, the substituted carbohydrate may be cellulose sulfate and the gypsum or precursor thereof may be calcium sulfate dihydrate.

Another implementation provides a gypsum wallboard. The gypsum wallboard includes (a) a core that includes calcium sulfate dihydrate, the core having two surfaces; and (b) cover sheets bonded to each of the two surfaces of the core. Each of the cover sheets have a bond surface with a composite coated thereon. The composite coating includes (i) a carbohydrate substituted sulfate moieties and (ii) gypsum or a precursor thereof. In some implementations, the substituted carbohydrate sulfur moieties may be cellulose sulfate and the gypsum or precursor thereof may be calcium sulfate dihydrate.

In another implementation, a method is provided for producing a gypsum wallboard. The method includes providing at least one paper cover sheet that has a bond surface with a composite coated on the bond surface. The composite includes (i) a carbohydrate substituted with sulfate moieties and (ii) gypsum or a precursor of gypsum. The method further includes casting an aqueous slurry comprising calcium sulfate hemihydrate on the at least one coated paper cover sheet and setting the slurry to form a gypsum core bonded to the paper cover sheet with the composite. In some implementations, the substituted carbohydrate may be cellulose sulfate and the gypsum or precursor thereof may be calcium sulfate dihydrate.

### BRIEF DESCRIPTION OF THE FIGURES

FIG. 1 illustrates an optical micrograph (magnification 200×) of an implementation of a composite formed by reacting microcrystalline cellulose with dilute sulfuric acid followed by crystallizing gypsum on the sulfated microfibrils upon reacting the remaining sulfuric acid with calcium hydroxide.

FIG. 2 illustrates an optical micrograph (magnification 200×) of an implementation of a composite formed by reacting microfibrillar cellulose with dilute sulfuric acid followed by crystallizing gypsum on the sulfated microfibrils upon reacting the remaining sulfuric acid with calcium hydroxide.

FIG. 3 illustrates optical micrographs (magnification 500×) of implementations of composites formed by sulfating 100 grams of microfibrillar cellulose followed by crystallizing gypsum on the sulfated microfibrils using (A) 10 grams of 1 N sulfuric acid and 100 grams of 0.1 N calcium hydroxide; (B) 20 grams of 1 N sulfuric acid and 200 grams of 0.1 N calcium hydroxide; (C) 30 grams of 1 N sulfuric acid and 300 grams of 0.1 N calcium hydroxide or (D) 40 grams of 1 N sulfuric acid and 400 grams of 0.1 N calcium hydroxide.

### DETAILED DESCRIPTION

The present invention provides a carbohydrate-gypsum composite which may be used as a bonding agent in manufacturing gypsum construction materials such as gypsum wallboard. The composite includes a carbohydrate component which may be a carbohydrate substituted with sulfate moieties and a gypsum component which may be calcium sulfate dihydrate.

The carbohydrate component of the composite may include any substituted carbohydrate. In general, a carbohydrate may be defined as a compound containing carbon, hydrogen and oxygen with the ratio of hydrogen and oxygen being about 2:1. Carbohydrates contain hydroxyl groups and, in most instances, either aldehyde or ketone groups. Carbohydrates include monosaccharides, oligosaccharides of from two to about ten monosaccharide units, and larger polysaccharides, which can contain hundreds of monosaccharide units. Non-limiting examples of the larger polysaccharides include starch such as amylose and amylopectin, glycogen, dextran, inulin, cellulose, hemicellulose, arabinoxylan, chitin, beta-glucan, glycosaminoglycans, agar, carrageenan, guar gum, pectin, xanthan gum, glucomannan and the like.

In some implementations, the carbohydrate component may be a sulfate-substituted cellulose which may be produced from a cellulose obtained from any of a variety of plant sources. For example, cotton fibers may contain nearly 100% cellulose, whereas the wood of bushes and trees may contain about 50% cellulose. In general, cellulose is a polymer of glucose that may be represented by the formula (C₆H₁₀O₅)ₙ where n may range from about 500 to about 5,000, depending on the source of the polymer.

Cellulose may be in the form of commercially available microcrystalline cellulose, which is generally produced by refining softwood pulp. The refining process may involve immersion in a hot bath of mineral acid to remove amorphous materials and to hydrolyze the alpha-cellulose fibers. This may then be followed by washing and spray drying to produce the microcrystalline cellulose in the form of particles of the desired size and moisture content. The cellulose may also be obtained by other methods of refining softwood pulp, such as, for example in water in a Valley beater by methods well known in the art (see, for example, Laboratory Beating of Pulp (TAPPI, T 200 sp-06: Laboratory beating of pulp (Valley beater method), in 2004-2005 TAPPI Test Methods. 2004, TAPPI Press: Atlanta, Ga.).

The sulfate-substituted form of the carbohydrate may be produced by substitution of hydroxyl groups of the carbohydrate with sulfate groups. In implementations in which the carbohydrate is cellulose, cellulose sulfate may be produced by any of a number of the methods known in the art. Typically sulfation of cellulose may be accomplished using sulfuric acid, chlorosulfonic acid, or sulfur trioxide/pyridine (see, for example, U.S. Pat. Nos. 2,539,451; 2,969,355; 3,624,069; 4,141,746 and 4,480,091; see also Phillip, B. and Wagenknecht, W. (1983) Cellulose sulfate half-ester. Synthesis, structure and properties. Cellulose Chem. Technol. 17:443-459). In one non-limiting example, cellulose sulfate may be produced by reacting cellulose with dilute sulfuric acid at a concentration of from about 0.05 N to about 1.5 N for a period of from about 5 min to about 2 hours at a temperature of from about 60° C. to about 80° C.

The degree of substitution (DS) of the carbohydrate with sulfate moieties depends upon the carbohydrate and the method of synthesis of the carbohydrate sulfate. Cellulose is a structural polysaccharide found in plants and made up of glucose units linked in a linear chain formation. Each glucose unit of the cellulose polymer has three hydroxyl groups which provide reactive centers for substitution with a sulfate moiety. The DS represents the average number of sulfate substitutions of hydroxyl groups in a glucose unit. Thus, the maximum attainable DS for cellulose sulfate is 3.0. The DS for the carbohydrate sulfate and, in particular, the cellulose sulfate of the composite of the present invention may range from about 0.05, about 0.1, about 0.2, about 0.3, about 0.4 or about 0.5 up to about 1.5, about 2.0, about 2.5 or about 3.0 and, in particular, about 0.05, about 0.1, about 0.2, about 0.3, about 0.4, about 0.5, about 0.6, about 0.7, about 0.8, about 0.9, about 1.0, about 1.1, about 1.2, about 1.3, about 1.4, about 1.5, about 1.6, about 1.7, about 1.8, about 1.9, about 2.0, about 2.1, about 2.2, about 2.3, about 2.4, about 2.5, about 2.6, about 2.7, about 2.8, about 2.9 or about 3.0.

The gypsum component of the composite of the present invention may be gypsum, i.e. calcium sulfate dihydrate or a precursor of gypsum such as calcium sulfate hemihydrate. In some implementations, the gypsum component may be calcium sulfate dihydrate and in such implementations, the calcium sulfate dihydrate may be formed by crystallization from calcium sulfate hemihydrate in the presence of cellulose sulfate microfibrils. In a non-limiting example, the composite may be formed by combining sulfuric acid and calcium hydroxide in the presence of the sulfated cellulose. The sulfuric acid and calcium hydroxide form stucco, i.e. calcium sulfate hemihydrate, which then crystallizes from aqueous medium to form gypsum, i.e. calcium sulfate dihydrate, in the presence of the cellulose sulfate microfibrils. Crystallization may be initiated by addition of a small amount of calcium sulfate hemihydrate to the mixture. The amount of initiating calcium sulfate hemihydrate may be from about 0.01 to about 0.05 (weight/weight) of the estimated amount of gypsum produced by reacting the sulfuric acid with calcium hydroxide. In some implementations, the composite may be constituted, at least in part, by calcium sulfate dihydrate crystals formed about cellulose sulfate fibers.

While not intending to be bound by any theory, it is believed that in some implementations, formation of the composite may involve incorporation of the sulfate moieties of the cellulose sulfate into the crystal structure of the calcium sulfate dihydrate during the crystallization process. Hence, in such implementations, the composite may comprise calcium sulfate dihydrate crystallized about the sulfated carbohydrate or cellulose fibers, in particular, in such a manner that the sulfate groups are incorporated into the calcium sulfate dihydrate crystals.

The ratio of gypsum or in some implementations gypsum precursor, to sulfated carbohydrate in the composite may be in the range of from about 0.1, about 0.2, about 0.5 or about 1.0 up to about 1.5, about 2.0 about 2.5, about 3.0, about 3.5, about 4.0, about 5.0 or greater on a weight/weight basis and, in particular, about 0.1, about 0.2, about 0.3, about 0.4, about 0.5, about 0.6, about 0.7 about 0.8, about 0.9, about 1.0, about 1.1, about 1.2, about, 1.3, about 1.4, about 1.5, about 1.6, about 1.6, about 1.8, about 1.9, about 2.0, about 2.1, about 2.2, about 2.3, about 2.4, about 2.5, about 3.0, about 3.5, about 4.0, about 5.0 or greater on a weight/weight basis.

In some implementations, one or more additives may be admixed with the sulfated carbohydrate and stucco to facilitate the crystallization process. In some instances, the additive may be a cationic flocculant such as, for example, a cationic starch or a cationic polyacrylamide. Other flocculants may also be used. The ratio of the amount of flocculant to the amount of stucco may be, for example, in the range of from about 0.001, about 0.002 or about 0.004 up to about 0.02, about 0.04 about 0.08 or greater on a weight/weight basis and, in particular, about 0.001, about 0.002, about 0.004, about 0.008, about 0.02, about 0.04 about 0.08 or greater on a weight/weight basis.

The composite of the present invention may be used as a bonding agent in the manufacture of gypsum construction materials such as gypsum wallboard. In such implementations, the composite is present at the interface between the paper backing and gypsum core of gypsum wallboard.

The paper backing used in making the gypsum wallboard may be made up of any type of thick paper or paperboard material such as, for example, unbleached Kraft paperboard, recycled paperboard, semichemical paperboard or solid bleached paperboard. Typically, this thick paper or paperboard will have a thickness of about 0.010 inches (10 mils), about 0.012 inches (12 mils), about 0.014 inches (14 mils), about 0.016 inches (16 mils) or about 0.020 inches (20 mils).

The gypsum core may be made up of calcium sulfate dihydrate formed from a calcium sulfate hemihydrate slurry which typically contains calcium sulfate hemihydrate, water as well as additives such as a foaming agent and stabilizers. Upon drying, the gypsum, i.e. calcium sulfate dihydrate is formed. In general, the gypsum core has a density in the range of about 10 lbs/ft³ up to about 60 lbs/f³ and, in particular, about 10, about 20 about 30, about 40, about 50 or about 60 lbs/ft³

Various methods may be used in making the gypsum wallboard in which the composite binds the paper backing to the gypsum core. In one non-limiting example, the composite may first be applied to the paper backing to be used in making the wallboard on the surface of the paper that is intended to be bonded to the gypsum core. The composite may be prepared in an aqueous suspension containing from about 0.8% to about 4.0% on a weight/weight basis. Various methods may be used in applying the composite suspension to the paper such as, for example, with a knife blade or by spray coating, dip coating or spin coating or any other methods of application that applies a relatively uniform layer of the composite to the paper backing. Typically, a coating layer of composite may be applied to the paper backing in an amount from about 0.04, about 0.06 or about 0.08 pounds per square foot up to about 0.10, about 0.20 or about 0.40 pounds per square foot and, in particular, about 0.04, about 0.06, about 0.08, about 0.10, about 0.12, about 0.14, about 0.16, about 0.18 about 0.20, about 0.22, about 0.24, about 0.26, about 0.28, about 0.30, about 0.32, about 0.34, about 0.36, about 0.38 or about 0.40 pounds per square foot. Multiple layers of composite may also be applied to the paper backing.

The gypsum wallboard may be formed by pouring a slurry of stucco, i.e. calcium sulfate hemihydrate onto the paper backing which is firmly held in place in some manner. Commercially, the slurry of stucco may be poured onto a layer of paper backing that is unrolling onto a long board machine. Another layer of paper unrolls on top of the slurry. The sandwich then passes through a system of rollers that compact the gypsum core to the proper thickness. Typically, the thickness of the wallboard may be about 0.375 inch, 0.5 inch, or 0.625 inch.

The following Examples further illustrate the invention and are not intended to limit the scope of the invention.

### EXAMPLES

### Example 1

This example illustrates the preparation of composite from microcrystalline cellulose, sulfuric acid and calcium hydroxide.

Two grams of microcrystalline cellulose were combined with 200 grams of 0.1 N sulfuric acid in a 500 ml flask. A suspension was formed and this was stirred for one hour at 70° C. using a hot plate, magnetic stirrer to produce a substitution of hydroxide groups on the cellulose. Two hundred grams of 0.1 N calcium hydroxide (Ca(OH)₂) was then added to the reaction mixture to stop the substitution reaction and to synthesize the gypsum crystals on the cellulose. A small amount (0.05 grams) of stucco was added to initiate the crystal formation in the suspension. The suspension was then stirred for 24 hours on a hot plate at 70° C. to allow the gypsum crystals to form.

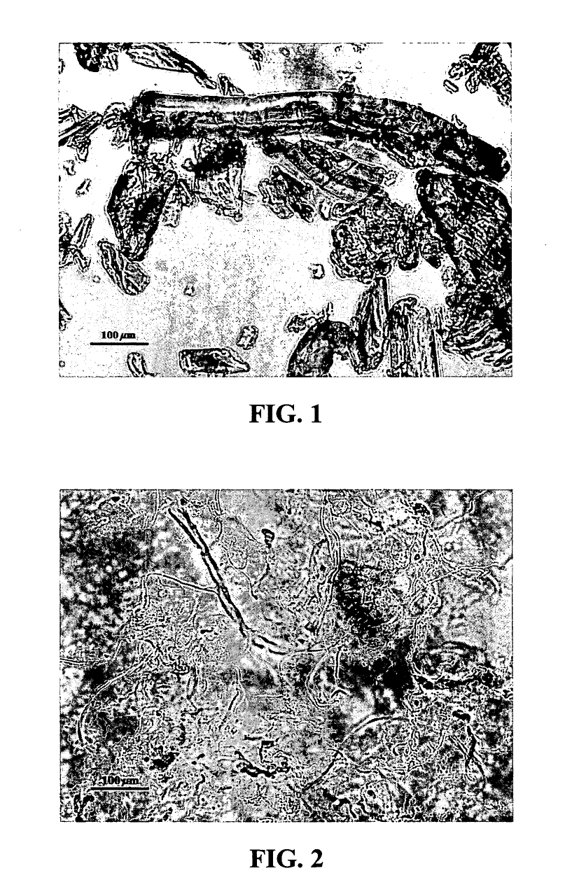

The cellulose sulfate/gypsum composite was observed and photographed using an optical microscope. As shown in FIG. 1, the composite produced by this process is made up of gypsum crystals formed on the surfaces of the microcrystalline microfibrils. The crystals are believed to be formed at the sulfate sites on the surfaces of the microfibrils.

### Examples 2-10

These examples illustrate various preparations of composite from microfibrillar cellulose, sulfuric acid and calcium hydroxide.

Microfibrillar cellulose was prepared in a 1% aqueous suspension by beating softwood pulp for at least 5 hours using a Valley beater. The microfibrillar cellulose was sulfated and gypsum crystals were formed on the cellulose as described in Example 1. FIG. 2 illustrates the composite produced by reacting 100 grams of a 1.5% suspension with 200 grams of 0.1 N H₂SO₄ followed by crystallization with 200 grams of 0.1 N Ca(OH)₂ (Example 2) in which gypsum crystals formed on the surfaces of the microcrystalline microfibrils.

In order to further evaluate the process, the various factors involved in the substitution and the crystallization components of the process were studied. The factors studied in the substitution component of the method were reaction time and the weight ratio of sulfuric acid to cellulose. In the crystallization component of the process, the factors studied were the expected percent of synthesized gypsum, the calculated solid percent of synthesized composite and the weight ratio of gypsum to cellulose. Tables 1 and 2 summarize the various conditions for substitution of cellulose and crystallization of gypsum to produce the composites of Examples 1-10.

TABLE 1

| | Cellulose | | H₂SO₄ | | | | |
|---|---|---|---|---|---|---|---|
| | Suspension | | | | % | H₂SO₄/ | Reaction |
| Example | Weight (g) | % | Weight (g) | (N) | in Suspension | Cellulose | time (hr) |
| 1 | 2 | 100 | 200 | 0.1 | 0.49 | 0.49 | 1 |
| 2 | 100 | 1.5 | 200 | 0.1 | 0.33 | 0.65 | 1 |
| 3 | 100 | 1.5 | 10 | 1.0 | 0.45 | 0.33 | 1 |
| 4 | 100 | 1.5 | 20 | 1.0 | 0.83 | 0.65 | 1 |
| 5 | 100 | 1.5 | 30 | 1.0 | 1.15 | 0.98 | 1 |
| 6 | 100 | 1.5 | 40 | 1.0 | 1.42 | 1.31 | 1 |
| 7 | 400 | 1.5 | 800 | 0.1 | 0.33 | 0.65 | 1 |
| 8 | 600 | 1.5 | 240.39 | 1.0 | 1.42 | 1.31 | 1/12 |
| 9 | 600 | 1.5 | 18.35 | 1.0 | 0.15 | 0.10 | 1 |
| 10 | 600 | 1.5 | 18.35 | 1.0 | 0.15 | 0.10 | 1 |

TABLE 2

| | Ca(OH)₂ | | Initiating | Expected | Calculated | Gypsum/ |
|---|---|---|---|---|---|---|
| Exam- | Weight | | Stucco | % of | % of | Cellulose |
| ple | (g) | (N) | (g) | Gypsum | Composite | Solid |
| 1 | 200 | 0.1 | 0.05 | 0.44 | 0.94 | 0.89 |
| 2 | 200 | 0.1 | 0.05 | 0.35 | 0.65 | 1.18 |
| 3 | 100 | 0.1 | 0.05 | 0.43 | 1.15 | 0.61 |
| 4 | 200 | 0.1 | 0.05 | 0.55 | 1.02 | 1.18 |
| 5 | 300 | 0.1 | 0.05 | 0.61 | 0.96 | 1.76 |
| 6 | 400 | 0.1 | 0.05 | 0.65 | 0.92 | 2.33 |
| 7 | 800 | 0.1 | 0.05 | 0.35 | 0.65 | 1.16 |
| 8* | 240.39 | 1.0 | 0.05 | 1.92 | 2.75 | 2.31 |
| 9 | 240.39 | 1.0 | 0.05 | 1.92 | 2.75 | 2.31 |
| 10 | 0.68 | Solid | 19.12 | 1.92 | 2.75 | 2.30 |

*During synthesis, 222.04 grams of 1 N H₂SO₄ were added after addition of Ca(OH)₂ to neutralize the suspension and increase the gypsum portion in the suspension.

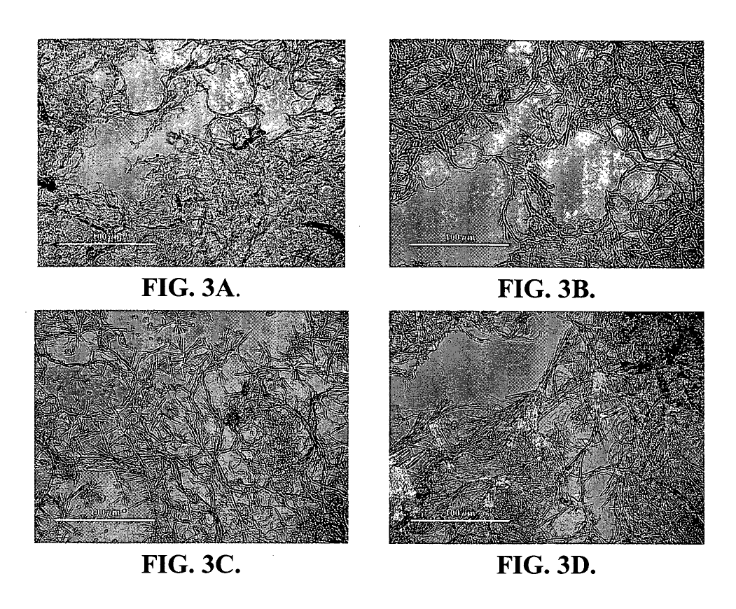

FIGS. 3A-3D show micrographs of the composites of Examples 3-6, respectively, in which gypsum crystals formed on the surfaces of the microcrystalline microfibrils.

### Example 11-19

These examples illustrate various preparations of composite from microfibrillar cellulose, sulfuric acid and calcium hydroxide in which a flocculant was added to facilitate gypsum crystallization.

Either cationic starch or cationic polyacrylamide was used as flocculant to modify the strength property of the synthesized composite. The composites were prepared as described in Examples 2-10 and flocculant was added prior to crystallization.

Examples 11 and 12 were identical to Examples 7 and 10, respectively, except that, 3.22 ml of 1% cationic starch solution was added to 1000 grams of each of the suspensions. The suspensions were then stirred for 10 min and crystallization was allowed to proceed as described in Examples 2-10.

Example 13 was prepared without flocculant as described above for Examples 2-10.

Examples 14 and 17 were prepared by combining 200 grams of suspension with 100 grams of water. Ten ml of 1% solution of either cationic starch (Example 14) or cationic polyacrylamide (Example 17) was then added and the suspension stirred for 10 min. Crystallization was then allowed to proceed as described in Examples 2-10.

Examples 15 and 18 were prepared by combining 200 grams of suspension with 100 grams of water followed by addition of 1 gram of stucco and stirring for 5 min. Ten ml of 1% solution of cationic starch (Example 15) or cationic polyacrylamide (Example 18) was then added and the suspension stirred for 10 min. This was followed by addition of 1 gram of stucco and stirring for 5 min. Crystallization was then allowed to proceed as described in Examples 2-10.

Examples 16 and 19 were prepared by combining 200 grams of suspension with 100 grams of water. Ten ml of 1% solution of either cationic starch (Example 16) or cationic polyacrylamide (Example 19) was then added and the suspension stirred for 10 min. One gram of stucco was then added and the suspension was stirred for 5 min. Crystallization was then allowed to proceed as described in Examples 2-10.

Table 3 summarizes the conditions for substitution of cellulose and crystallization of gypsum to produce the composite of Examples 11-19.

TABLE 3

| | Cellulose | | | | | | | | |
|---|---|---|---|---|---|---|---|---|---|
| | Suspension | | H₂SO₄ | | Reaction | Ca(OH)₂ | | | |
| | Weight | | Weight | Conc. | time | Weight | Conc. | Stucco | |
| Example | (g) | % | (g) | (N) | (hr) | (g) | (N) | (g) | Flocculant** |
| 11 | 400 | 1.5 | 800 | 0.1 | 1 | 800 | 0.1 | 0.05 | C-starch |
| 12 | 600 | 1.5 | 18.35 | 1.0 | 1 | 0.68 | Solid | 19.12 | C-starch |
| 13* | 1000 | 1.5 | 195.74 | 1.0 | 1 | 14.5 | Solid | 0 | None |
| 14* | 1000 | 1.5 | 195.74 | 1.0 | 1 | 14.5 | Solid | 0 | C-starch |
| 15* | 1000 | 1.5 | 195.74 | 1.0 | 1 | 14.5 | Solid | 2 | C-starch |
| 16* | 1000 | 1.5 | 195.74 | 1.0 | 1 | 14.5 | Solid | 1 | C-starch |
| 17* | 1000 | 1.5 | 195.74 | 1.0 | 1 | 14.5 | Solid | 0 | C-PAM |
| 18* | 1000 | 1.5 | 195.74 | 1.0 | 1 | 14.5 | Solid | 2 | C-PAM |
| 19* | 1000 | 1.5 | 195.74 | 1.0 | 1 | 14.5 | Solid | 1 | C-PAM |

*During synthesis, 241 grams of 1 N H₂SO₄ was added after addition of Ca(OH)₂ to neutralize the suspension and increase the gypsum portion in the suspension.
**C-starch is cationic starch and C-PAM is cationic polyacrylamide.

### Example 20

This example illustrates the preparation of gypsum boards using the composites of Examples 1-19.

### Preparation of Gypsum Board Using PVC Ring Mold

Composites from Examples 1-12 were each applied to the surface of a piece of paperboard using a Gardco AP-1/2×28 coating rod (Paul N. Gardner Co., Inc., Pompano Beach, Fla.). The coated paper was air-dried for five to ten minutes and used in forming the gypsum board without complete drying.

A stucco slurry was formed by combining water and stucco in a ratio of 0.7/1 on a weight/weight basis and mixing well. The slurry was then poured into a PVC ring mold that had been placed on a coated paper sheet, which in turn was on a steel course-wire sheet and a galvanized steel plate. After the PVC ring mold was filled, the stucco was then covered with a second coated paper sheet and a second course-wire steel sheet and galvanized steel plate to compress the pad sample during formation of the gypsum. After forming the gypsum board, the galvanized steel plates and steel course wire sheets were removed. The gypsum board was then dried as described below. Non-treated gypsum board samples were also prepared using paperboard sheets that were not coated with composite.

### Preparation of Gypsum Board Using Envelope-Type Mold

Composites from Examples 13-19 were each applied to the surface of a piece of paperboard using a Gardco blade film former. The coating thickness was varied on different sheets of paperboard by coating the paperboard once (OC), twice (DC) or three times (TC) followed by air drying overnight. The coated paperboards were then made into envelopes and placed in a frame form that held the side walls of the envelopes in place during pouring of the stucco slurry and formation of the gypsum board.

A stucco slurry was formed by combining water and stucco in a ratio of 0.7/1 on a weight/weight basis and mixing well. The slurry was then poured into an envelope held in the frame and allowed to set for about 4 minutes. The gypsum pad thus formed was then removed from the frame for drying.

The gypsum boards made with PVC or with envelope were dried in an oven. Gypsum boards made with the composites of Examples 1 and 2 were dried in an oven at 105° C. for 24 hours. Gypsum boards made with the composites of Examples 3-19 were dried in an oven at 105° C. for 1 hour followed by air drying overnight.

### Example 21

This example illustrates the testing of bond strength of gypsum boards made with paperboard coated with various composites from the previous examples.

The paper-gypsum interfacial bonding strength was tested with a Z-directional tensile tester (ZDT-tester, model 4411; Instron, Norwood, Mass.). Both sides of the gypsum board sample were attached to the instrument faces using 3M, 1-inch-by-1-inch double-sided mounting foam tapes. A gypsum pad was placed on the bottom module in the ZDT-tester with the tapes placed on the top and bottom surfaces of the gypsum pad. The ZDT-tester made the measurement by first moving the instrument face slowly down onto the upper tape to press the tapes against the surfaces of the gypsum board sample for effective attachment. The compression load was from about 15 to about 40 kN/m² and this was maintained for 30 seconds. Then, the tension mode was then applied to test the breakage load at the interfacial surface of the sample. Values of tensile stress at machine peak load are reported in the tables below.

### Effects of Microcrystalline or Microfibillar Cellulose Composites on Tensile Stress.

The tensile stress in kN/m² of gypsum boards made with uncoated paper, paper coated with the composite of Example 1 and paper coated with the composite of Example 2 are shown in Table 4. As shown in the table, the tensile stress of gypsum board made with paper coated the composite of Example 2, which was made with microfibrillar cellulose, exhibited greater tensile stress than gypsum board made with paper coated with the composite of Example 1, which was made with microcrystalline cellulose.

TABLE 4

| | | Tensile stress of | Tensile Stress of |
|---|---|---|---|
| | | Gypsum Board | Gypsum Board |
| | | made with Paper | made with Paper |
| | Tensile Stress of | Coated | Coated with |
| | Non-treated | with Composite of | Composite of |
| Sample | Gypsum Board- | Example 1* | Example 2** |
| Replicate | (kN/m²) | (kN/m²) | (kN/m²) |
| 1 | 6.45 | 19.39 | 15.76 |
| 2 | 26.82 | 30.96 | 131.71 |
| 3 | 25.27 | 46.61 | 97.25 |
| 4 | 19.16 | 48.32 | 131.08 |
| 5 | 64.30 | — | 110.69 |
| 6 | — | — | 147.65 |
| Mean | 28.40 | 36.32 | 105.69 |
| Standard | 21.61 | 13.73 | 47.47 |
| Deviation | | | |
| Maximum | 64.30 | 48.32 | 147.65 |
| Minimum | 6.45 | 19.39 | 15.76 |

*Composite made with microcrystalline cellulose
**Composite made with microfibrillar cellulose.

### Effect of H₂SO₄/Cellulose Ratio on Tensile Stress.

The next series of comparisons evaluated the relationship of the ratio of sulfuric acid to cellulose (H₂SO₄/Cellulose) and composite bonding strength. Table 5 illustrates the values for tensile stress for gypsum boards made with paperboard coated with the composites of Examples 3-6 (H₂SO₄/cellulose ratios of 0.33, 0.65, 0.98 and 1.31, respectively). As the H₂SO₄/cellulose ratio increased, the higher amounts of H₂SO₄ to cellulose might have been expected to produce more sulfate sites on the surface of the micofibrillar cellulose and, as a result, increase bonding strength of the composite. However, the results in Table 5 show that the H₂SO₄/cellulose ratio during substitution was not linearly related to the bond strength of the paper and gypsum core.

TABLE 5

Tensile Stress (kN/m²)

| Example | 3 | 4 | 5 | 6 |
|---|---|---|---|---|
| H₂SO₄/Cellulose | 0.33 | 0.65 | 0.98 | 1.31 |
| Sample No. | — | — | — | — |
| 1 | 91.72 | 115.31 | 97.83 | 46.36 |
| 2 | 55.06 | 88.59 | 75.91 | 72.59 |
| 3 | 61.96 | 115.98 | 84.19 | 161.99 |
| 4 | 44.80 | 82.85 | 88.01 | 114.57 |
| 5 | 62.31 | 132.95 | 71.85 | 132.25 |
| Mean | 63.17 | 107.14 | 83.56 | 105.55 |
| Std. Dev. | 17.47 | 20.89 | 10.24 | 46.28 |
| Maximum | 91.72 | 132.95 | 97.83 | 161.99 |
| Minimum | 44.80 | 82.85 | 71.85 | 46.36 |

### Effect of Gypsum/Cellulose Ratio on Tensile Stress.

The next series of comparisons, evaluated the relationship of the ratio of gypsum to cellulose (gypsum/cellulose) in addition to the H₂SO₄/cellulose ratio on tensile stress. Table 6 illustrates the values for tensile stress for gypsum boards made with paperboard coated with the composites of Examples 7-12. As shown in the table, the H₂SO₄/cellulose ratio of the composite of Example 8 is 1.31, which is much higher than the value of 0.10 of the composite of Example 9. Nevertheless, tensile stress of gypsum boards made with the composite of Examples 8 was not substantially greater than that of Example 9. This further supports the conclusion that the ratio of H₂SO₄/cellulose was not linearly related to the bond strength of the paper and gypsum core.

On the other hand, as also shown Table 6, the gypsum board made with paper coated with the composites of Examples 8-10 had a higher gypsum/cellulose ratio and also higher values of tensile stress than that of gypsum board made with paper coated with the composite of Example 7. The tensile stresses shown for the composites of Examples 9 and 10 were, thus, higher than that of the composite of Example 7 due to the higher gypsum/cellulose ratio even though the composites of Examples 9 and 10 had a much lower acid to cellulose ratio than that of Example 7. The tensile stress measured for the composite of Example 8 was a little greater than that measured for the composite of Example 9 even though the composites of both Examples 8 and 9 had the same gypsum/cellulose ratio and different acid/cellulose ratios, however, the difference in the mean values for tensile stress were not substantial in comparison to the magnitude of the standard deviation of the data sets. Therefore, of the components used to make the composite, the ratio of gypsum/cellulose is concluded to be more important than the ratio of acid to cellulose in determining the bonding strength of the composite.

Another important factor in determining bond strength of these composites may be the solid content of stucco in the suspension prior to crystallization of gypsum. This is suggested from comparison of the composite of Example 10 with the composites of Examples 8 and 9. During the synthesis of the composite of Example 10, Ca(OH)₂ was added in solid form in order to neutralize the solution and form crystalline gypsum as shown in Table 2. In contrast to this, the composites of Examples 8 and 9 were prepared with 1N Ca(OH)₂ solution as also shown in Table 2. In addition to this, a greater amount of stucco was added in the synthesis of the composite of Example 10 than was added in the synthesis of the composites of Examples 8 or 9 as further shown in Table 2. Therefore, it is possible that more gypsum is crystallized on the cellulose sulfate as a result of a greater amount of stucco added to the suspension in the preparation of the composite of Example 10.

In addition, gypsum board made with paper coated with composite containing cationic starch showed a further improvement in tensile stress. This is apparent from comparison of tensile stress of gypsum boards made with paper coated with composites not containing cationic starch (Examples 7 and 10) to tensile stress of gypsum boards coated with corresponding composites containing cationic starch (Examples 11 and 12).

TABLE 6

| | Tensile Stress (kN/m²) | | | | | |
|---|---|---|---|---|---|---|
| | Example | | | | | |
| | 7 | 8 | 9 | 10 | 11* | 12* |
| | Gypsum/cellulose | | | | | |
| | 1.16 | 2.31 | 2.31 | 2.30 | 1.16 | 2.30 |
| | H₂SO₄ /cellulose | | | | | |
| | 0.65 | 1.31 | 0.10 | 0.10 | 0.65 | 0.10 |
| | Starch %** | | | | | |
| | 0 | 0 | 0 | 0 | 0.50 | 0.12 |
| Sample No. | — | — | — | — | — | — |
| 1 | 96.46 | 92.96 | 94.88 | 130.58 | 74.95 | 168.19 |
| 2 | 59.76 | 112.44 | 107.82 | 126.21 | 133.54 | 170.20 |
| 3 | 72.64 | 81.27 | 72.64 | 100.59 | 112.10 | 161.68 |
| 4 | 176.25 | 104.57 | 104.54 | 142.11 | 113.48 | 133.57 |
| 5 | 84.19 | 123.17 | 90.17 | 115.73 | 79.77 | 129.00 |
| Mean | 84.43 | 103.32 | 96.53 | 124.17 | 101.78 | 154.48 |
| Std. Dev. | 45.88 | 16.37 | 13.91 | 15.72 | 24.76 | 19.71 |
| Maximum | 176.25 | 123.17 | 107.82 | 142.11 | 133.54 | 170.20 |
| Minimum | 59.76 | 81.27 | 72.64 | 100.59 | 74.95 | 129.00 |

*Examples 11 and 12 were identical to Examples 7 and 10, respectively, but with added C-starch flocculant.
**Starch % was calculated by dividing the solid weight of added C-starch flocculant (3.22 ml of 1% solution) by the total calculated solid gypsum carbohydrate composite in suspensions of Example 11 (0.65% of 1000 grams; see Table 2, Example 7) or Example 12 (2.75% of 1000 grams; see Table 2, Example 10).

### Effect of Cationic Polymer Flocculant on Tensile Stress.

The next series of comparisons further evaluated the effect of cationic starch or cationic polyacrylamide on tensile stress of the composites. Table 7 illustrates the values for tensile stress for gypsum boards made with paper coated with the composites of Examples 13-19. As shown in Table 3 above, Example 13 was prepared with no flocculent, Examples 14-16 were prepared with cationic starch and Examples 17-19 were prepared with cationic polyacrylamide. Each of the composites were tested when applied with one coat (OC), two coats (DC) or three coats (TC) on the paper prior to making the gypsum paperboard.

As shown in Table 7, addition of cationic starch and cationic polyacrylamide to the gypsum/cellulose composite generally improved the strength of the bond between the paper and the gypsum core. A mean tensile stress of up to 188.32 kN/m² was measured with gypsum board made with paper having three coatings of the gypsum-cellulose composite containing flocculant. Tensile stress thus tended to be higher in the presence of cationic starch or cationic polyacrylamide (Examples 14-19) than that in the absence of either of the cationic polymers (Example 13). Also, the order of addition of the stucco and the cationic polymer did not seem to affect the strength of the paper gypsum bond in a significant manner as is illustrated in the comparison of Examples 14, 15 and 16 or Examples 17, 18 and 19. Samples with added solid stucco seemed to have higher levels of bonding between paper and gypsum at least in composites containing cationic starch (Examples 14-16). Also, a strong relationship was seen between the number of coats applied to the paper sheet and the paper/gypsum bond strength. Higher numbers of coating passes generally resulted in a higher level of paper/gypsum bond strength. In general, it also appeared that composites containing cationic polyacrylamide produced a greater bond strength than composites containing cationic starch.

TABLE 7
Tensile Stress (kN/m²)

| Example | Coating* | 1 | 2 | 3 | 4 | Mean | S.D. | Max. | min. |
|---|---|---|---|---|---|---|---|---|---|
| 13 | OC | 22.63 | 55.78 | 58.85 | 60.06 | 49.33 | 17.89 | 60.06 | 22.63 |
| | DC | 22.89 | 22.07 | 109.90 | 96.91 | 62.94 | 47.02 | 109.90 | 22.07 |
| | TC | 101.37 | 119.63 | 113.31 | 87.67 | 105.49 | 14.09 | 119.63 | 87.67 |
| 14 | OC | 14.63 | 18.06 | 44.52 | 38.24 | 28.86 | 14.74 | 44.52 | 14.63 |
| | DC | 146.51 | 157.79 | 101.62 | 165.85 | 142.94 | 28.67 | 165.85 | 101.62 |
| | TC | 157.95 | 97.74 | 113.48 | 155.78 | 131.23 | 30.29 | 157.95 | 97.74 |
| 15 | OC | 83.96 | 116.54 | 197.63 | 107.82 | 126.49 | 49.38 | 197.63 | 83.96 |
| | DC | 186.16 | 129.95 | 153.65 | 196.23 | 166.50 | 30.39 | 196.23 | 129.95 |
| | TC | 189.10 | 147.51 | 159.34 | 175.46 | 167.85 | 18.22 | 189.10 | 147.51 |
| 16 | OC | 64.08 | 105.20 | 46.36 | 110.47 | 81.53 | 31.30 | 110.47 | 46.36 |
| | DC | 178.25 | 173.45 | 204.76 | 227.85 | 196.08 | 25.26 | 227.85 | 173.45 |
| | TC | 209.87 | 183.21 | 197.16 | 158.26 | 187.12 | 22.11 | 209.87 | 158.26 |
| 17 | OC | 175.60 | 146.23 | 117.06 | 166.01 | 151.22 | 25.85 | 175.60 | 117.06 |
| | DC | 170.19 | 202.12 | 170.81 | 96.88 | 160.00 | 44.65 | 202.12 | 96.88 |
| | TC | 224.13 | 170.35 | 151.16 | 179.03 | 181.16 | 30.92 | 224.13 | 151.16 |
| 18 | OC | 91.54 | 67.12 | 177.63 | 35.15 | 92.86 | 61.05 | 177.63 | 35.15 |
| | DC | 206.46 | 94.38 | 131.86 | 144.60 | 144.32 | 46.59 | 206.46 | 94.38 |
| | TC | 219.79 | 259.78 | 117.30 | 156.40 | 188.32 | 63.66 | 259.78 | 117.30 |
| 19 | OC | 130.70 | 92.67 | 72.21 | 139.14 | 108.68 | 31.62 | 139.14 | 72.21 |
| | DC | 194.37 | 232.35 | 120.42 | 119.97 | 166.78 | 55.98 | 232.35 | 119.97 |
| | TC | 198.25 | 167.40 | 181.51 | 204.14 | 187.82 | 16.65 | 204.14 | 167.40 |

*Composites were applied to paper with one coat (OC), two coats (DC) or three coats (TC).

All literature references and similar materials cited in this application, including, patents, patent applications, articles, books, treatises, and internet web pages are expressly incorporated by reference in their entirety for any purpose. In the event that one or more of the incorporated literature references uses a term in such a way that it contradicts that term's definition in this application or makes a statement that contradicts or is inconsistent with the teachings in this application, this application and its teachings are controlling.

What is claimed is:

1. A carbohydrate-gypsum composite comprising (i) a carbohydrate substituted with sulfate moieties and (ii) gypsum or a precursor thereof.

2. The composite of claim 1, where the substituted carbohydrate is cellulose.

3. The composite of claim 2, where the substituted cellulose is cellulose sulfate.

4. The composite of claim 3, where the cellulose sulfate has a degree of substitution of from about 0.05 to about 3.

5. The composite of claim 1, where the gypsum or a precursor thereof includes calcium sulfate dihydrate.

6. The composite of claim 1, where the ratio of gypsum or precursor thereof to substituted carbohydrate is from about 0.1 to about 5.0 on a weight/weight basis.

7. The composite of claim 1 formed by crystallizing gypsum in the presence of the carbohydrate substituted with sulfate moieties.

8. The composite of claim 7, further comprising a flocculent of cationic starch or cationic polyacrylamide.

9. A method of making a carbohydrate-gypsum composite comprising (i) a carbohydrate substituted with sulfate moieties and (ii) gypsum or a precursor thereof, the method comprising:
(a) providing a carbohydrate substituted sulfate moieties; and
(b) combining the substituted carbohydrate with gypsum or a precursor thereof to form the composite.

10. The method of claim 9, where the carbohydrate substituted with sulfate moieties is a cellulose sulfate.

11. The method of claim 10, where the cellulose sulfate has a degree of substitution of from about 0.05 to about 3.

12. The method of claim 9, where providing the substituted carbohydrate includes reacting unsubstituted carbohydrate with sulfuric acid to produce the substituted carbohydrate.

13. The method of claim 9, where combining includes crystallizing calcium sulfate dihydrate in the presence of the substituted carbohydrate to form the composite.

14. The method of claim 13, where crystallizing is in the presence of a flocculent of cationic starch or cationic polyacrylamide.

15. The method of claim 9, where the ratio of gypsum or precursor thereof to substituted carbohydrate in the composite is from about 0.1 to about 5 on a weight/weight basis.

16. A method for producing gypsum wallboard, the method comprising:
(a) providing at least one paper cover sheet having a bond surface with a composite coated thereon, the composite comprising (i) a carbohydrate substituted with sulfate moieties and (ii) gypsum or precursor thereof;
(b) casting an aqueous slurry comprising calcium sulfate hemihydrate on the at least one coated paper cover sheet; and
(c) setting the slurry to form a gypsum core bonded to the paper cover sheet with the composite.

17. The method of claim 16, where the substituted carbohydrate of the composite is a cellulose sulfate.

18. The method of claim 17, where the cellulose sulfate has a degree of substitution of from about 0.05 to about 3.

19. The method of claim 16, where the gypsum or a precursor thereof includes calcium sulfate dihydrate.

20. The method of claim 16, where the ratio of gypsum or precursor thereof to substituted carbohydrate is from about 0.1 to about 5.0 on a weight/weight basis.
